(19) United States
(12) Patent Application Publication
(10) Pub. No.: US 2015/0269566 A1
(43) Pub. Date: Sep. 24, 2015

(54) SYSTEMS AND METHODS FOR LOCALLY DERIVED TOKENS

(71) Applicants: Ajit Gaddam, Sunnyvale, CA (US); Selim Aissi, Menlo Park, CA (US)

(72) Inventors: Ajit Gaddam, Sunnyvale, CA (US); Selim Aissi, Menlo Park, CA (US)

(21) Appl. No.: 14/661,922

(22) Filed: Mar. 18, 2015

Related U.S. Application Data
(60) Provisional application No. 61/955,157, filed on Mar. 18, 2014.

(51) Int. Cl. G06Q 20/36

(52) U.S. Cl. CPC G06Q 20/3674

(57) ABSTRACT

Systems and methods for generating a token are provided. An access device may receive, from a token vault computer, an encryption key and a credential identifier. The access device may generate a token using the encryption key and a current time. The access device may then transmit the token, the current time, and the credential identifier to the token vault computer. The token vault computer may receive the token, a current time, and a credential identifier. The token vault computer may retrieve an encryption key associated with the received credential identifier. The token vault computer may then validate the token based at least in part on the received current time and the retrieved encryption key.

### CROSS-REFERENCES TO RELATED APPLICATIONS

This application is a non-provisional application of and claims the benefit of priority to U.S. Provisional Application No. 61/955,157, filed on Mar. 18, 2014, which is herein incorporated by reference in its entirety for all purposes.

### BACKGROUND

Tokens have been used to conduct payment transactions instead of real account numbers. If a token is obtained by an unauthorized person, the exposure to the real account number is limited, because the token can be canceled immediately without affecting the underlying account.

A conventional token transaction system is illustrated in FIG. 1. In the conventional token transaction system, a communication device 110 such as a mobile phone is in communication with a token generator 120. The token generator 120 is responsible for the generation and registration of tokens. In a payment transaction, the communication device 110 requests a token from the token generator 120 and upon verification, the token generator 120 generates, registers, and returns the token to the communication device 110. The token request may include the user's real account number or the real account number may be stored with the token generator 120. The communication device 110 then initiates a payment transaction with a merchant 115. The merchant 115 generates an authorization request message with the payment token and transmits it to the payment processor network 130. The payment processor network 130 then forwards the authorization request message to the issuer 140 for authorization. The issuer 140 may then contact the token generator 120 to determine the real account number associated with the token and may authorize or not authorize the transaction. The issuer 140 may then transmit an authorization response message back to the merchant 115 and/or the communication device 110 with its authorization decision.

While the conventional token transaction system is useful, improvements can be made. For example, the conventional token transaction system requires that the communication device 110 have an online connection with the token generator 120, in order to request generation of a token. If for some reason the online connection with the token generator 120 is unavailable, the communication device 110 may not be able to receive a token from the token generator 120. In such case, a payment transaction may not be successfully completed.

Embodiments of the invention address these and other problems, individually or collectively.

### BRIEF SUMMARY

In some embodiments of the invention, systems and methods for generating a token at an access device are provided. In many cases, a user may desire to conduct a transaction at a merchant using a token, but may not have connectivity to a token provider server and/or may not have a device suitable for securely receiving a token. In such cases, embodiments of the invention allow a token to be generated offline at an access device of a merchant. The access device may be offline in that it temporarily may not be capable of communicating with an acquirer computer and/or a token vault computer. Once the access device is online, may send the token to the token provider for verification. Once the token has been verified, one or more transactions using the token may be conducted.

Some embodiments of the invention are directed to a method including receiving, by an access device and from a token vault computer, an encryption key and a credential identifier. The method may also include generating, by the access device, a token using the encryption key and a current time. In some embodiments, the encryption key may be a session key. The method may also include transmitting, by the access device, the token, the current time, and the credential identifier to the token vault computer.

In some embodiments, transmitting the token and the current time to the token vault computer is performed after communication between access device and the token vault computer is restored, wherein the token vault computer validates the token using the current time and the encryption key.

In some embodiments, validating the token further comprises retrieving the encryption key based at least in part on the credential identifier received by the token vault computer.

In some embodiments, the method also includes sending, by the access device, authentication credentials to the token vault computer, wherein the token vault computer validates the authentication credentials, and storing, by the access device, the credential identifier and the encryption key on the access device.

In some embodiments, the method also includes receiving account information from a communication device, wherein the account information comprises at least a primary account number (PAN).

In some embodiments, the token vault computer stores information pertaining to an association between the token and the account information.

In some embodiments, generating the token comprises generating a token having a token identifier from within a predefined Bank Identification Number (BIN) range

Some embodiments of the invention are directed to a method for offline token generation including receiving, by a token vault computer and from an access device, a token, a current time, and a credential identifier. The method also includes retrieving, by the token vault computer, an encryption key associated with the received credential identifier. The method additionally includes validating, by the token vault computer, the token based at least in part on the received current time and the retrieved encryption key, wherein the token is generated by the access device.

In some embodiments, the method also includes further comprising storing, by the token vault computer, an association between the received token and information pertaining to a user account.

Other embodiments of the invention are directed to communication devices, servers, and systems that are configured to perform the above-described methods.

These and other embodiments of the invention are described in further detail below.

### BRIEF DESCRIPTION OF THE DRAWINGS

FIG. 1 shows a block diagram of a typical token transaction system.

FIG. 2A shows a block diagram of a payment transaction system supporting token generation by an access device, in accordance with some embodiments of the invention.

FIG. 2B shows a block diagram of an access device having an active network communication with a token vault computer 270, in accordance with some embodiments of the invention.

FIG. 2C shows a block diagram of an access device having an inactive network communication with a token vault computer 270, in accordance with some embodiments of the invention.

FIG. 3 shows a flowchart of an exemplary method of registering an access device with a token vault computer token generation, in accordance with some embodiments of the invention.

FIG. 4 shows a flowchart of an exemplary method of generating a token at an access device, in accordance with some embodiments of the invention.

FIG. 5 shows a flow diagram illustrating data exchanged between an access device and a token vault computer in accordance with some embodiments of the invention, in accordance with some embodiments of the invention.

FIG. 6 shows exemplary computer apparatus, in accordance with some embodiments of the invention.

### DETAILED DESCRIPTION

Prior to discussing embodiments of the invention, descriptions of some terms may be helpful in understanding embodiments of the invention.

An “authorization request message” may be an electronic message that is sent to an authorization system such as a payment processing network and/or an issuer computer to request authorization for a transaction. An authorization request message is an example of a transaction message. An authorization request message according to some embodiments may comply with ISO 8583, which is a standard for systems that exchange electronic transaction information associated with a payment made by a consumer using a payment device or a payment account. The authorization request message may comprise a primary account number (PAN), expiration date, service code, CVV and other data from a payment device. In some embodiments of the invention, an authorization request message may include a payment token (e.g., a substitute or pseudo account number), an expiration date, a token presentment mode, a token requestor identifier, an application cryptogram, and an assurance level data. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, by way of example only: a service code, a CVV (card verification value), a dCVV (dynamic card verification value), an expiration date, etc.

An “authorization response message” may be an electronic message reply to an authorization request message generated by the authorization system. The authorization response message may include an authorization code, which may be a code that the authorization system returns in response to receiving an authorization request message (either directly or through the payment processing network). The authorization response message is received at the merchant's access device (e.g. POS terminal) and can indicate approval or disapproval of the transaction by the authorization system.

An “access device” can include a device that allows for communication with a remote computer, and can include a device that enables a customer makes a payment to a merchant in exchange for goods or services. An access device can include hardware, software, or a combination thereof. Examples of access devices include point-of-sale (POS) terminals, mobile phones, tablet computers, laptop or desktop computers, automobiles with remote communication capabilities, etc.

A “virtual wallet” or “digital wallet” may refer to an electronic device that allows an individual to make electronic commerce transactions. This can include purchasing items on-line with a computer or using a communication device (e.g., smartphone) to purchase an item at a physical store. The “virtual wallet” or “digital wallet” can consist of the system (the electronic infrastructure), the application (the software that operates on top), and the device (the individual portion). An individual's bank account can also be linked to the virtual wallet. The individual may also have their driver's license, health card, loyalty card(s), and other ID documents stored within the virtual wallet.

A “virtual wallet provider” or “digital wallet provider” may include any suitable entity that provides a virtual wallet service or digital wallet service. A virtual wallet provider may provide software applications that store account numbers, account numbers including unique identifiers, or representations of the account numbers (e.g., tokens), on behalf of an account holder to facilitate payments at more than one unrelated merchant, perform person-to-person payments, or load financial value into the virtual wallet.

“Contactless” or “wireless” can include any communication method or protocol, including proprietary protocols, in which data is exchanged between two devices without the need for the two devices to be physically coupled. For example, “contactless” or “wireless” can include radio frequency (RF), infrared, laser, or any other communication means, and the use of any protocols, such as proprietary protocols, with such communication means.

A “payment token” or a “token” may include any identifier for a payment account that is a substitute for an account identifier. For example, a token may include a series of alphanumeric characters that may be used as a substitute for an original account identifier. For example, a token “4900 0000 0000 0001” may be used in place of a primary account identifier or primary account number (PAN) “4147 0900 0000 1234.” In some embodiments, a token may be “format preserving” and may have a numeric format that conforms to the account identifiers used in existing payment processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

A “token vault computer” may be a computer configured to validate and in some cases, store, a token. The token vault computer may be associated with an entity such as a payment processing network, a wallet provider, a merchant, an authentication cloud, an acquirer or an issuer.

An “encryption key” may be a piece of information that determines the functional output of a cryptographic algorithm. The encryption key may be used to generate a token from a primary account number (PAN). The encryption key may be a symmetric encryption key and may also be used to decrypt the token back into the PAN.

The encryption key may be stored by a device that generates the token and by a device that receives and validates the token. For example, in some embodiments, the access device may store the encryption key to generate the token and the token vault computer may store the encryption key to validate the token. In some embodiments, the encryption key may be a session key that is only used for a single session and is used to generate a single token.

A “credential identifier” or “domain identifier” may be an identifier that identifies a particular access device. The credential identifier may provide assurance to another entity (e.g., token vault computer) that the access device is authorized to generate the token that it may have generated. The credential identifier may be based on particulars of the access device. For example, a credential identifier could be “Access Device 13, Safeway, Menlo Park, Calif.”. Otherwise, the credential identifier may simply be a string of numbers, letters, or alphanumeric characters (e.g., “518219A3”). Examples of credential identifiers may also include device IDs, SIM card IDs, IMEI numbers, etc.

Embodiments of the invention enable generation of a token(s) at an access device. In some cases, a user may desire to conduct a transaction at a merchant using a token, but the access device at the merchant may not have connectivity to a token provider server and/or may not have a device suitable for securely receiving a token. For example, the connectivity to the token provider may be experiencing a temporary outage, or the user's communication device may not support meet the necessary requirements for a token transaction

In such cases, embodiments of the invention allow a token to be generated at an access device of a merchant so that tokens can be generated even though the access device temporarily cannot communicate with a token vault computer. In order to determine whether the access device can communicate with the token vault computer, the access device may send a test communication or data packet to the token vault computer and wait a predetermined period of time to receive an acknowledgement of the data packet back from the token vault computer. Even if the access device temporarily cannot communicate with the token vault computer, the access device may still conduct the transaction such that a user can still purchase goods and/or services even though the communication is temporarily unavailable. Once communications with the token vault computer are restored, the access device may then send the token to the token provider for verification. The following description may refer to the token as being generated “offline” at the access device, simply meaning that the token is not generated by a token provider computer.

Embodiments of the invention provide several technical advantages. For example, embodiments of the invention allow the benefits of using tokens (e.g., security and efficiency) to be realized in situations that may commonly preclude their use (e.g., in offline environments where connectivity to the token provider is unavailable). In addition, in some embodiments of the invention, tokens may be both user and merchant-specific. This may improve token security because even if a token is stolen from a user, the token may only be used at a single merchant (typically the merchant which is associated with the access device where the token was generated).

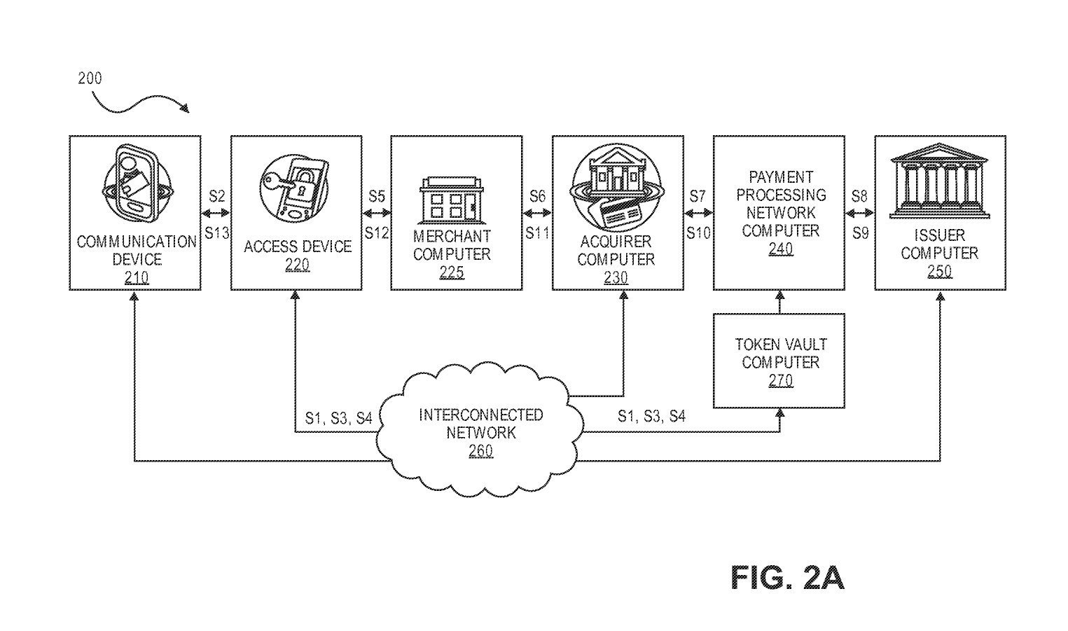

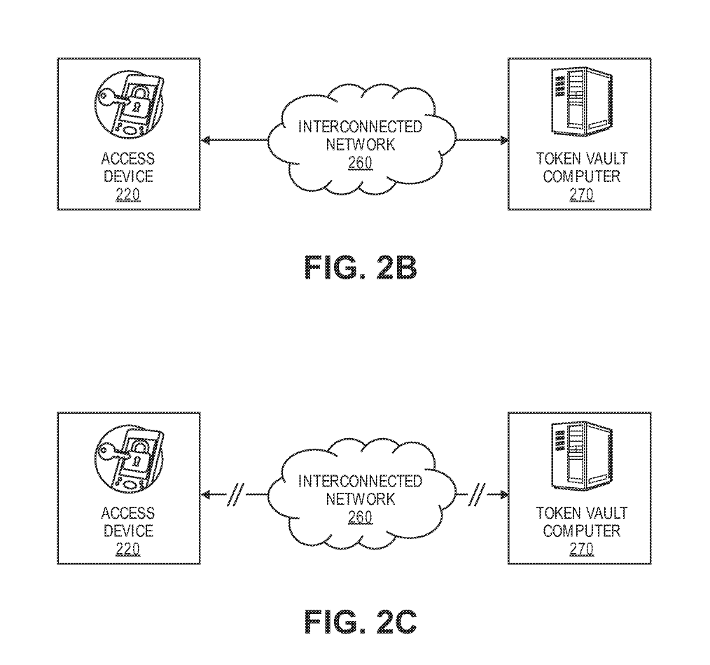

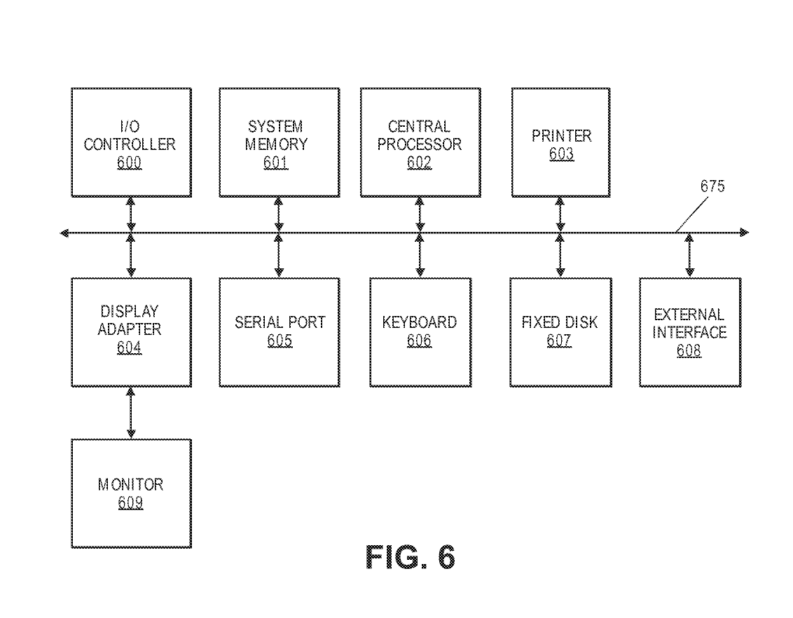

FIG. 2A shows a block diagram of a payment transaction system 200 supporting token generation by an access device 220, in accordance with some embodiments of the invention. The payment transaction system 100 may include a communication device 210, an access device 220, a merchant computer 225, an acquirer computer 230, a payment processing network computer 240, an issuer computer 250, and a token vault computer 270. In some implementations, different entities in FIG. 2A may communicate with each other using one or more communication networks such as the Internet, a cellular network, a TCP/IP network or any other suitable communication network such as interconnected network 260. Note that one or more entities in the payment transaction system 200 may be associated with a computer apparatus that may be implemented using some of the components as described with reference to FIG. 6.

The communication device 210 may be associated with a payment account of a user. In some implementations, the communication device 210 may be a mobile device such as a mobile phone, an automobile with remote communication capabilities, a tablet computer, a PDA, a notebook computer, a wearable device (e.g., smart watch), payment card, a key fob or any suitable mobile device. In some embodiments, the communication device 210 may be a wearable device such as, but not limited to, a smart watch, a fitness band, an ankle bracelet, a ring, earrings, etc. The communication device 210 may also include a virtual wallet or a payment application that may be associated with one or more payment accounts of the user. In some implementations, the communication device 210 may be capable of communicating with the access device 220 using a wireless data protocol such as Wi-Fi™, Bluetooth™, or NFC. For example, the communication device 210 may interact with the access device 220, via a virtual wallet application or payment application running on the communication device 210, by establishing a connection with the access device 220 using a wireless data protocol.

The access device 220 may be an access point to a transaction processing system. In some embodiments, the transaction processing system may comprise the acquirer computer 230, the payment processing network computer 240, and the issuer computer 250. In some implementations, the access device 220 may be associated with or operated by the merchant computer 225. For example, the access device 220 may be a point of sale (POS) device that may include a contactless reader, an electronic cash register, a display device, etc. In some implementations, the access device 220 may be configured to transmit information pertaining to one or more purchased items at a merchant computer 225 to an acquirer computer 230 or payment processing network computer 240. In some implementations, the access device 220 may be a personal computer that may be used by the user to initiate a transaction with the merchant computer 225 (e.g., an online transaction). In e-commerce transactions, the access device 220 could be a merchant server computer that operates a merchant Website. In some embodiments, the access device 220 may be configured to generate a token that can be used in in the transaction.

The acquirer computer 230 may be operated by an acquirer. The acquirer is typically a system for an entity (e.g., a bank) that has a business relationship with a particular merchant, a wallet provider or another entity. The acquirer computer 230 may be communicatively coupled to the merchant computer 225 and the payment processing network computer 240 and may issue and manage a financial account for the merchant. The acquirer computer 230 may be configured to route the authorization request for a transaction to the issuer computer 250 via the payment processing network computer 240 and route an authorization response received via the payment processing network computer 240 to the merchant computer 225.

The payment processing network computer 240 may be configured to provide authorization services, and clearing and settlement services for payment transactions. The payment processing network computer 240 may include data processing subsystems, wired or wireless networks, including the internet. An example of the payment processing network computer 240 includes VisaNet™, operated by Visa®. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. The payment processing network computer 240 may include a server computer. In some implementations, the payment processing network computer 240 may forward an authorization request received from the acquirer computer 230 to the issuer computer 250 via a communication channel. The payment processing network computer 240 may further forward an authorization response message received from the issuer computer 250 to the acquirer computer 230. The payment processing network computer 240 may also be associated with a token vault computer 270. In some embodiments, the token vault computer 270 may reside within the payment processing network, or its functions may entirely reside within the payment processing network computer 240.

The issuer computer 250 may represent an account issuer and/or an issuer processor. Typically, the issuer computer 250 may be associated with a business entity (e.g., a bank) that may have issued an account and/or payment card (e.g., credit account, debit account, etc.) for payment transactions. In some implementations, the business entity (bank) associated with the issuer computer 250 may also function as an acquirer (e.g., the acquirer computer 230).

The issuer computer 250 and/or the payment processing network computer 240 may operate as authorization systems in some embodiments of the invention.

The token vault computer 270 may work in conjunction with the access device 220 to facilitate token generation. The token vault computer 270 may provide the access device 220 with an encryption key that can be used by the access device 220 to generate tokens. The encryption key provided to the access device 220 may also be stored on the token vault computer 270 in order to validate the token when the generated token is received by the token vault computer 270. The token vault computer 270 may also store associations between account information and tokens generated for each of the accounts and/or encryption keys associated with the accounts. For example, token vault computer 270 may maintain a database comprising tokens and primary account numbers (PANs) for one or more user accounts. In some embodiments, token vault computer 270 may be associated with or incorporated by acquirer computer 230, payment processing network computer 240, or issuer computer 250.

The various entities in the system 100 may communicate with each other via an interconnected network 160, e.g., the Internet. An interconnected network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Each of the entities may comprise one or more computer apparatuses (e.g., merchant computer 225, acquirer computer 230, payment processing network computer 240, issuer computer 250, and token vault computer 270) to enable communications, or to perform one or more of the functions described herein. Secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like may be used in embodiments of the invention.

The interaction of the various entities described above may be better understood by the following flow describing token generation on the access device 220.

Prior to having authorization to generate a token(s), the access device 220 may need to register with the token vault computer 270. The registration processed may only need to be completed once for each access device 220, so that the access device 220 is authorized by the token vault computer 270 to generate tokens. At step s1, the access device 220 may send authentication credentials to the token vault computer 270. The authentication credentials can be any data or other information suitable to authenticate the access device 220 or a merchant associated with access device 220. For example, the authentication credentials may include a username, password, and/or digital certificate. The access device 220 may communicate with the token vault computer 270 via interconnected network 260 in order to send the authentication credentials. The token vault computer 270 may verify the received authentication credentials and authorize the token access device 220 to generate a token(s) by sending back at least a credential identifier for the access device and an encryption key to the access device 220. The access device 220 may store the received credential identifier and encryption key locally.

The encryption key may be dynamic (e.g., changes with every transaction), semi-dynamic (may be changed after a predetermined number of transactions are conducted or after a predetermined time such as a day, week, or month), or permanent (changed only if necessary for a security update or not at all).

At step s2, a user may conduct a transaction at an access device 220 belonging to a merchant computer 225 using his/her communication device 210. The transaction may be a payment transaction (e.g., for the purchase of a good or service), an access transaction (e.g., for access to a transit system), or any other suitable transaction. For example, in one embodiment, the user begins the transaction by tapping his/her communication device 210 against an NFC reader in the access device 220. Alternatively, the user may indicate account information to the merchant electronically, such as in an online transaction. In some cases, the communication device 220 may transmit an account identifier to the access device 220, such as a token.

At step s3, the access device 220 may generate a token for the transaction using the stored encryption key and the current time. The current time may be determined in any suitable manner. For example, a UNIX system call may be used to determine the local time. Alternatively, a trusted time server may be used to determine the current time. Still alternatively, the access device 220 may have an internal clock. The time when the token was generated may be saved as a “token timestamp.” The token may be generated such that it is a representation of the account information received from the communication device 210 by the access device in step s2.

The token may be generated from the encryption key and timestamp in any suitable manner. For example, in some embodiments, the token may be generated using an HMAC-based one-time password (HOTP) algorithm, where the encryption key is used as the secret key, and the current time is used as a variable input. The token may also be generated using a time-based one-time password (TOTP) algorithm, where the encryption key is used as the secret key and the current time is used as the time counter. In some embodiments, the value generated by the HOTP or TOTP algorithms may be formatted to match the account information. For example, if the account information is a 16-digit PAN, the token may be the result of the HOTP or TOTP operation modulus 10̂16. Additionally, the generated token may not be readily predictable by a fraudster. For example, the token may be generated using a pseudo-random number generator (PRNG) to prevent guessing attacks by a fraudster.

In some embodiments, the generated token may be associated with a “token expiration time.” The token expiration time may indicate the last time at which a token is valid. The token expiration time may be determined, for example, by adding a desired token lifetime value to the current time. The value of the token expiration time may be determined by an agreement between an operator of the token vault computer 270 and the merchant.

If the access device 220 is in communication with the token vault computer 270 via a functioning communication network, the access device 220 may send the token to the token vault computer 270 for validation. If however, the access device 220 does not have an available communication network to access the token vault computer 270 (e.g., the network is unavailable), the access device 220 may defer transmission of the token to the token vault computer 270 until a later time. In this case, once the token is generated, the user may receive and/or use the goods or services, and/or be granted access to such before the transaction is authorized online.

In some embodiments, the merchant may set a limit on the transaction amount if it is determined that the access device 220 cannot communicate with the token vault computer 270. For example, the access device 220 may only allow transactions under $100 to be completed when a communication with the token vault computer 270 is unavailable. Transactions above the $100 risk threshold may be denied by the merchant when communications to the token vault computer 270 is unavailable. Later, depending on network access, processing time, or other constraints, an online authorization or verification may be conducted using the token by sending the token to the token vault computer 270 for validation. Along with sending the token, the access device 220 may also send the credential identifier, the token timestamp (or derivative thereof), and the account information (e.g., PAN) to the token vault computer 270. In some embodiments, all or part of the transmission to the token vault computer 270 (e.g., the account information and token) may be encrypted using the encryption key or a separate session key (e.g., using the SSL/TLS or IPsec protocols). The following steps of the flow may apply to embodiments of the invention, whether or not the access device 220 has available network access to the token vault computer 270.

At step s4, the token vault computer 270 may validate the token received from the access device 220. The token vault computer 270 may retrieve the encryption key associated with the received credential identifier. For example, in some embodiments, the token vault computer 270 may maintain a database associating a credential identifier and an encryption key for one or more access devices 220. In embodiments of the invention, the database storing the token information may be illustrated as follows:

| Access Device Credential | | |
|---|---|---|
| Identifier | Encryption Key | Valid Time Range |
| 382958888 | dxJ1eif8L772 | 1-1-14 to 1-13-14 |
| 382958218 | De88dd1953 | 2-1-14 to 3-15-15 |
| 394819288 | D2827s882z | 2-2-14 to 2-3-14 |
| 283938259 | 39c6fneJ2k1 | 2-5-14 to 3-5-14 |

Validating the received token may include re-generating the token using the encryption key and the received token timestamp. If the re-generated token does not match the received token, validation may fail. In addition, if the current time is past the token expiration time, validation may fail. Furthermore, if a token is already associated with account information, validation may be rejected in order to prevent replay attacks. However, if the re-generated token matches the received token, the token expiration time has not been reached, and the token is unique, the token may be validated by the token vault computer 270. The token vault computer 270 may provide a message back to the access device 220 indicating that the token has been validated and the transaction may proceed.

In some embodiments, if the token is validated, the token vault computer 270 may store an association between the token and the received account information (e.g., PAN) in a database. The token vault computer 270 may also provide a confirmation of the validation and association of the token to the access device 220. In response, the access device 220 may delete the account information and store the token locally (e.g., in a persistent memory).

At step s5, after the access device 220 is online (assuming that it was previously offline) and after the access device 220 has communicated the token to the token vault computer 270 and the token vault computer has verified the token, the access device 220 may generate and send an authorization request message and may then forward it to the acquirer computer 230. The authorization request message may include the generated token and the other data elements described above. The authorization request message does not include the PAN associated with the user's account and instead the generated token may serve as a secure representation of the PAN. At step s6, after receiving the authorization request message, the authorization request message may be sent to the payment processing network computer 240, by the acquirer computer 230.

At step s7, the acquirer computer 230 may forward the authorization request message to the payment processing network computer 240. The payment processing network computer 240 may communicate with the token vault computer 270 in order to verify that the token received in the authorization request message has been validated by the token vault computer 270. If the token has been validated by the token vault computer 270, the payment processing network computer 240 may feel confident that the token is genuine and may replace the token with the actual PAN. The actual PAN may be provided to the payment processing network computer 240 by the token vault computer 270, from the association stored on the token vault computer 270 of the generated token and the PAN.

At step s8, The payment processing network computer 240 may then forward the authorization request message (which now includes the actual PAN) to the corresponding issuer computer 250 associated with an issuer associated with the user's account.

At step s9, after the issuer computer 250 receives the authorization request message, the issuer computer 250 may authorize or deny the transaction based on the received PAN and various other factors. If the issuer computer 250 authorizes the transaction, the issuer computer 250 may send an authorization response message back to the payment processing network computer 240 to indicate whether the current transaction is authorized (or not authorized). The authorization response message back to the payment processing network computer 240 may still include the actual PAN.

At step s10, the payment processing network computer 240 may replace the actual PAN with the token once again. The payment processing network computer 240 may then forward the authorization response message (which now includes the token instead of the actual PAN) back to the acquirer computer 230. In some embodiments, the payment processing network computer 240 may decline the transaction even if issuer computer 250 has authorized the transaction, for example depending on a value of the fraud risk score.

At step s11, the acquirer computer 230 may then send the response message back to the merchant computer 225.

At step s12, after the merchant computer 225 receives the authorization response message, the merchant computer 225 may then provide the authorization response message for the user by sending the message to the access device 220 or to the communication device 210 directly. The response message may be displayed by the access device 220, or may be printed out on a physical receipt. At step s13, if the message was not send to the communication device 210 directly, the access device 220 may notify the communication device 210 that the transaction was successful. Alternately, if the transaction is an online transaction, the merchant may provide a web page or other indication of the authorization response message as a virtual receipt. The receipts may include transaction data for the transaction. At this point, the access device 220 may have the token stored locally and the account information received from the communication device 210 may have already been purged from the access device's 220 memory. The token may be used in the future for another transaction initiated by the communication device 210 and the same user account, or may need to be generated again if the access device 220 is provisioned for one-time use only tokens.

At the end of the day, a normal clearing and settlement process can be conducted by the payment processing network 105. A clearing process may be a process of exchanging financial details between an acquirer and an issuer to facilitate posting to a customer's payment account and reconciliation of the user's settlement position.

It should be noted that some steps may be performed offline without any connection to token vault computer 270. In some embodiments, if the access device 220 has an available network communication with the token vault computer 270, the access device may conduct the transaction similar to a typical token transaction where the token vault computer 270 may generate the token. If the access device 220 determines that the network communication to the token vault computer 270 is unavailable, the access device 220 may generate the token locally. In other words, it is possible for the access device 220 to always generate the token, or to generate the token only when the network communication with the token vault computer 270 is unavailable.

FIG. 2B shows a block diagram of an access device having an active network communication with a token vault computer 270, in accordance with some embodiments of the invention. The access device 220 has an active network communication with the token vault computer 270 via the interconnected network 260. In one example, the interconnected network could be the Internet. The access device 220 may communicate with the token vault computer 270 by sending and receiving data packets over the interconnected network 260. As described above, the access device 220 may generate a token irrespective of whether the network communication with the token vault computer 270 is available/active or may leave token generation to the token vault computer 270 (e.g., a typical token transaction) if the network communication is available/active.

FIG. 2C shows a block diagram of an access device having an inactive network communication with a token vault computer 270, in accordance with some embodiments of the invention. The network communication with the token vault computer 270 may be inactive for a number of reasons. For example, there could be a network outage, planned network maintenance, denial of service (DoS) attack, or any other multitude of factors that could cripple or paralyze the network. In such a case, the access device 220 may not be able to successfully send a data packet to the token vault computer 270. As mentioned earlier, typical payment transactions would suffer in this scenario because the access device 220 would not be able to communicate with the token vault computer 270 and the transaction would not be able to take place. However, embodiments of the invention allow for the access device 220 to generate the token locally, allow the user to purchase the goods/services, and obtain validation of the token and authorization of the transaction when the network connection with the token vault computer 270 is restored.

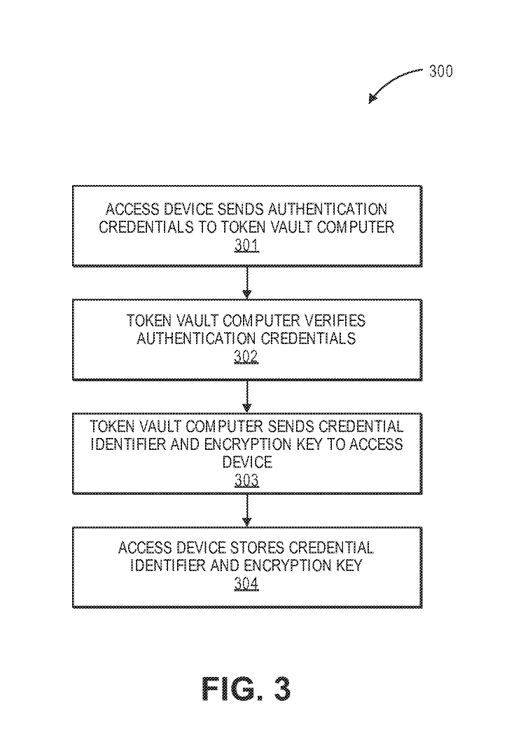

FIG. 3 shows a flowchart of an exemplary method 300 of registering an access device with a token vault computer token generation, in accordance with some embodiments of the invention. Typically, method 300 may be performed once for a token vault computer 270 to establish an encryption key and a credential identifier between the access device 220 and token vault computer 270. After performing the method 300, the access device 220 may generate tokens offline.

At step 301, the access device 220 may send authentication credentials to the token provider 270. The authentication credentials can be any data or other information suitable to authenticate the access device 220 or a merchant associated with access device 220. For example, the authentication credentials may include a username, password, and/or digital certificate. In some embodiments, authentication credentials may not be required if a trusted relationship exists between the access device 220 and the token vault computer 270.

At step 302, the token vault computer 107 may verify the authentication credentials received from the access device 220. For example, the token vault computer 270 may verify that the authentication credentials match those on file for a merchant associated with the access device 220.

At step 303, the token vault computer 270 may send a credential identifier and an encryption key to the access device 220. A “credential identifier” may include any number, string, or other data suitable to identify the access device 220. For example, a credential identifier may be the serial number of access device 220. In some cases, a credential identifier may be a shared secret between the access device 220 and token vault computer 270. In another example, the credential identifier could be an alphanumeric data string describing the access device 220 (e.g., “Access Device 35, Safeway Location #422, Redwood City, Calif.”). In some embodiments, the token vault computer 270 may also send an encryption key expiration time, indicating when the encryption key expires and may no longer be used for token generation. At such a time, the access device 220 may need to perform the method 300 again from step 301 in order to re-register with the token vault computer 270 and obtain a new encryption key. The token vault computer 270 may set the encryption key expiration time based on a risk factor associated with the registering access device 220. For example, the token vault computer 270 may set a lower value for the encryption key expiration time for an access device 220 at a gas station, which is typically a high-risk/high-fraud environment.

In some embodiments, the token vault computer 270 may send a “primary token” to reside within the access device 220. The access device 220 may then locally generate tokens that are derived from the primary token (e.g., a many-to-one mapping). The primary token may have its own expiration time at which a new primary token would need to be obtained from the token vault computer 270. The generated tokens derived from the primary token may be generated using any suitable algorithm. The “primary token” could perform a function to an encryption key in that a token may be derived therefrom, so it may be considered an encryption key in embodiments of the invention.

An “encryption key” may include any encryption key or other data used to encrypt communication between the access device 220 and the token vault computer 270. The encryption key may be an encryption key in a symmetric format (e.g., DES, AES, Blowfish), or a combination of asymmetric keys (e.g., public/private key pairs).

At step 304, the access device may stores the received credential identifier and encryption key in memory. In some embodiments, the credential identifier and the encryption key may be stored in a secure storage medium, such as a tamper-resistant device (TRD) or a hardware security module (HSM).

The method 300 may be performed any suitable number of times. For example, in some embodiments, each access device 220 may be associated with a different token provider. In such cases, the registration method 300 may be performed for each token provider. In other embodiments, such as those where a single token provider is used for all transactions, the method 300 may only be performed in relation to that token provider. The process shown in FIG. 3 may be performed prior to every transaction, for a predetermined number of transactions, at specific intervals of time, etc.

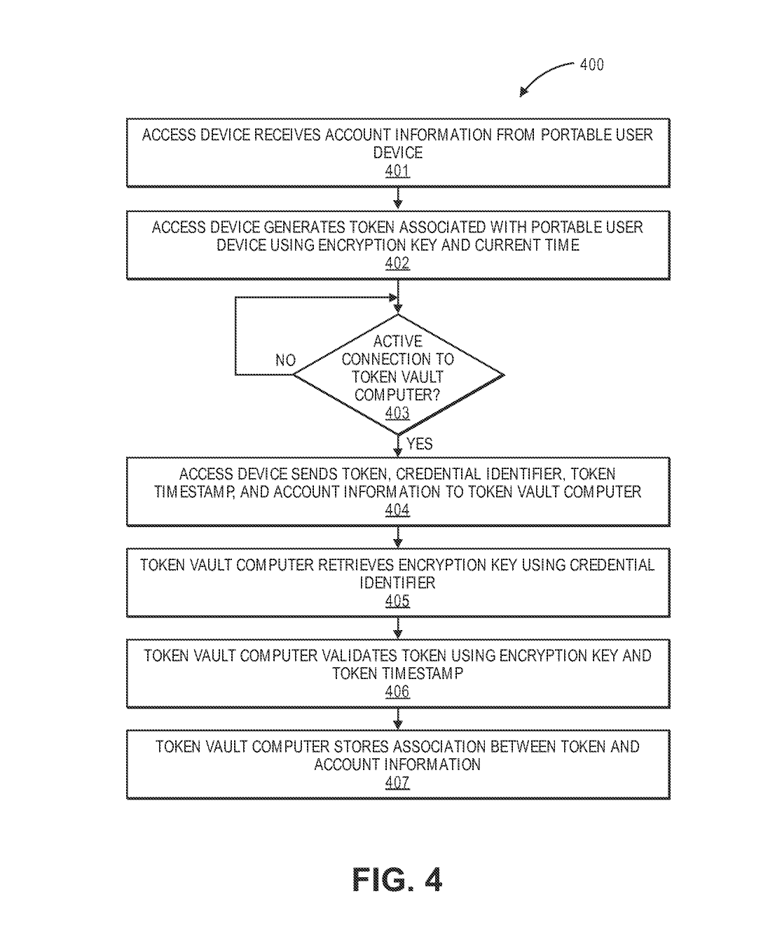

FIG. 4 shows a flowchart of an exemplary 400 method of generating a token at an access device 220, in accordance with some embodiments of the invention. In some cases, the method 400 may be performed when a user desires to conduct a transaction using a communication device 210.

At step 401, the access device 220 may receive account information from a communication device 210. The account information may include any data stored on communication device 210, such as an account number (e.g., a primary account number or PAN), a user's name, or an expiration date.

At step 402, the access device 220 may generate a token associated with communication device 210 using an encryption key and the current time. If the communication device 210 is associated with a token provider, the encryption key received from the associated token vault computer 270 during the method 300 described above in relation to FIG. 3 may be used. The current time may be determined in any suitable manner. For example, a UNIX system call may be used to determine the local time. Alternatively, a trusted time server may be used to determine the current time. The time used to generate the token is saved as a “token timestamp.” In some embodiments, the generated token may be from a set of defined bank identification number (BIN) ranges for the token. The BIN range may be sent by the token vault computer 270. This may allow for enhanced security as the token may only be used at certain merchants and with certain token vault computers 270.

The token may be generated from the encryption key and timestamp in any suitable manner. For example, in some embodiments, the token may be generated using an HMAC-based one-time password (HOTP) algorithm, where the encryption key is used as the secret key, and the current time is used as the counter. The token may also be generated using a time-based one-time password (TOTP) algorithm, where the encryption key is used as the secret key and the current time is used as the time counter. In some embodiments, the value generated by the HOTP or TOTP algorithms may be formatted to match the account information. For example, if the account information is a 16-digit PAN, the token may be the result of the HOTP or TOTP operation modulus 10̂16.

In some embodiments, the generated token may be associated with a “token expiration time.” The token expiration time may indicate the last time at which a token is valid. The token expiration time may be determined, for example, by adding a desired token lifetime value to the current time. The access device 220 may expunge the token upon reaching the token expiration time.

At step 403, the access device may make a determination whether an active connection to the token vault computer 270 is available. If an active connection to the token vault computer 270 is not available, the method 400 my wait until the active connection is restored. However, the access device 220 may still “complete” the purchase in the sense that the user may be allowed to take the goods/services and from his/her point of view, complete the transaction. If desired, since actual online authorization cannot be performed when the access device 220 is offline, the merchant computer 225 or other entity may wish to limit this type of transaction to those with an acceptable level of risk (e.g., for transactions less than $200). The access device 220 may complete authorization of the transaction once the active connection to the token vault computer 270 is restored and the token vault computer 270 has verified the token. The verification of the token may occur well after the consumer has obtained the purchased goods or services and has left the merchant.

At step 404, the communication device 210 may send the generated token, the credential identifier for the token provider, the token timestamp, and the account information to token vault computer 270. In some embodiments, all or part of the transmission (e.g., the account information and token) may be encrypted using the encryption key (e.g., using the SSL/TLS or IPsec protocols).

At step 405, token vault computer 270 may retrieve the encryption key associated with the received credential identifier. For example, in some embodiments, the token vault computer 270 may maintain a database associating a credential identifier and an encryption key for one or more access devices 220.

At step 406, token vault computer 270 may validate the received token. Validating the received token may include re-generating the token using the encryption key and received token timestamp. If the re-generated token does not match the received token, validation may fail. In addition, if the current time is past the token expiration time, validation may fail. Furthermore, if a token is already associated with account information, validation may be rejected in order to prevent replay attacks. However, if the re-generated token matches the received token, the token expiration time has not been reached, and the token is unique, the token may be validated. The validation of the token may also depend on a risk level associated with the received token. If a risk level associated with the received token is perceived to be high, the token vault computer 270 may not validate the token.

At step 407, if the token is validated, the token vault computer 270 may store an association between the token and the received account information. The token vault computer 270 may also provide a confirmation of the validation and association of the token to the access device 220. In response, the access device 220 may delete the account information and store the token (e.g., in a persistent memory).

The access device 220 may then conduct a transaction using the token. In some embodiments, the transaction may be conducted in accordance with the systems and methods described for FIG. 2. In some embodiments, the token may only be a one-time use token where the token vault computer may not validate the token after a successful validation has already been issued for the token before. This may help prevent replay attacks by fraudsters. The next time a user using the communication device 210 wishes to conduct a transaction at the access device 220, a new token may need to be generated.

It should be noted that steps 401 and 402 may be performed offline without any connection to token vault computer 270. For example, in one use case, a user may present communication device 210 for a payment transaction. A merchant may accept the communication device 210, perform steps 401 and 402 of method 400, and exchange goods or services with the user. At a later time (e.g., when an internet connection is available), the merchant using access device 220 and/or merchant computer 225 may complete steps 403-407 of method 400.

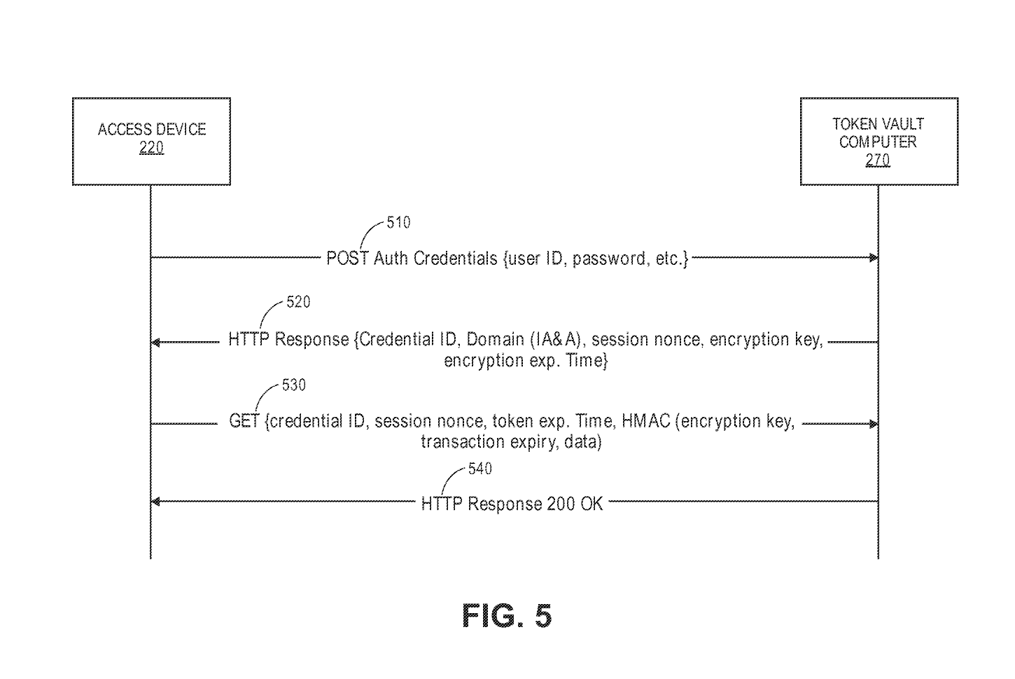

FIG. 5 shows a flow diagram illustrating data exchanged between an access device 220 and a token vault computer 270 in accordance with some embodiments of the invention.

As shown in FIG. 5, the flow begins with an HTTP POST message from the access device 220 to the token vault computer 270 including authentication credentials such as, for example, a user ID and password. In response, the token vault computer 270 may send an HTTP response message including a credential identifier, an identity, authentication, and authorization (IA&A) domain, a session nonce, an encryption key, and an encryption key expiration time to access device 220. Access device 220 may store the received data to complete the registration process with the token vault computer 270.

Later, in order for the access device 220 to have a generated token validated by the token vault computer 270, the access device 102 may submit an HTTP GET request to the token vault computer 270 including the credential identifier, the session nonce, the token expiration time of the generated token, and an HMAC of the encryption key, token, the token expiration time, and any data (e.g., account information). The HMAC may be generated using the encryption key.

If the token is validated using the methods described above, the token vault computer 270 may send an HTTP response message with status 200, indicating approval of the token. The transaction authorization may then continue by the access device 220 sending an authorization request message to the acquirer computer 230.

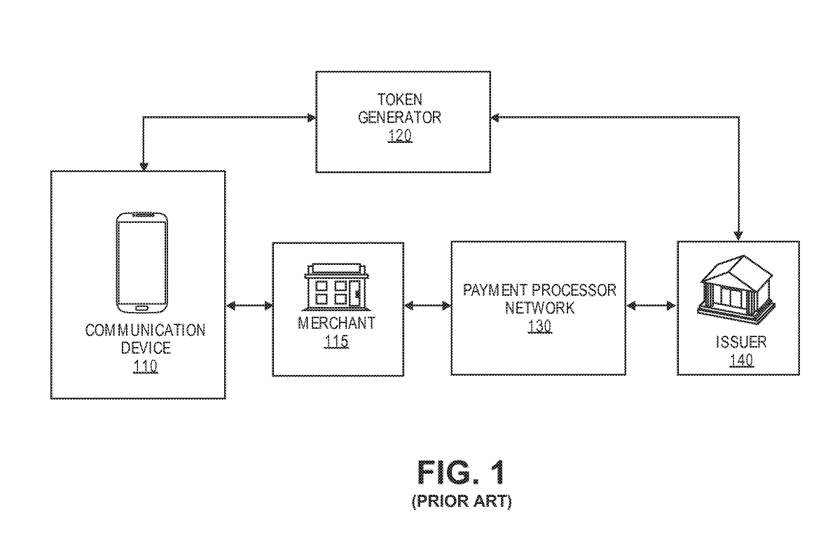

It should be noted that although embodiments of the invention are described in relation to FIGS. 1-5, the embodiments are not so limited. For example, in some cases, a user may return to a merchant that generated a token for a user during a previous transaction. In such cases, the merchant may re-use the token generated for the user. For example, when the token for a communication device 120 is stored in step 407 of method 400, the token may be associated with a hash of the PAN of communication device 210. If a user presents the communication device 210 in a subsequent transaction, the hash of the PAN of the communication device 210 may be used to retrieve the previously generated token. Thus, a transaction may be conducted using the token without requiring a later connection to a token vault computer 270 to validate the token.

In addition, in some embodiments, other entities, such as the communication device 210 or merchant computer 225, may take the place of access device 220 in registration method 300 and token generation method 400. For example, in embodiments where the communication device 210 generates tokens, the tokens may be communicated to the access devices 220 in order to conduct transactions.

The various participants and elements described herein with reference to FIGS. 1-5 may operate one or more computer apparatuses to facilitate the functions described herein. Any of the elements in FIGS. 1-5, including any servers or databases, may use any suitable number of subsystems to facilitate the functions described herein.

Examples of such subsystems or components are shown in FIG. 6. The subsystems shown in FIG. 6 are interconnected via a system bus 645. Additional subsystems such as a printer 644, keyboard 658, fixed disk 649 (or other memory comprising computer readable media), monitor 646, which is coupled to display adapter 682, and others are shown. Peripherals and input/output (I/O) devices, which couple to I/O controller 641 (which can be a processor or other suitable controller), can be connected to the computer system by any number of means known in the art, such as serial port 684. For example, serial port 684 or external interface 681 can be used to connect the computer apparatus to a wide area network such as the Internet, a mouse input device, or a scanner. The interconnection via system bus allows the central processor 643 to communicate with each subsystem and to control the execution of instructions from system memory 637 or the fixed disk 649, as well as the exchange of information between subsystems. The system memory 637 and/or the fixed disk 649 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for generating a token, comprising:
receiving, by an access device and from a token vault computer, an encryption key and a credential identifier;
generating, by the access device, a token using the encryption key and a current time; and
transmitting, by the access device, the token, the current time, and the credential identifier to the token vault computer.

2. The method of claim 1, wherein after receiving the encryption key, the access device temporarily does not have communication with the token vault computer.

3. The method of claim 2, wherein transmitting the token and the current time to the token vault computer is performed after communication between access device and the token vault computer is restored, wherein the token vault computer validates the token using the current time and the encryption key.

4. The method of claim 3, wherein validating the token further comprises retrieving the encryption key based at least in part on the credential identifier received by the token vault computer.

5. The method of claim 1, further comprising:
sending, by the access device, authentication credentials to the token vault computer, wherein the token vault computer validates the authentication credentials; and
storing, by the access device, the credential identifier and the encryption key on the access device.

6. The method of claim 1, further comprising receiving account information from a communication device, wherein the account information comprises at least a primary account number (PAN).

7. The method of claim 1, wherein the token vault computer stores information pertaining to an association between the token and the account information.

8. The method of claim 1, wherein generating the token comprises generating a token having a token identifier from within a predefined Bank Identification Number (BIN) range.

9. An access device for generating a token, comprising:
a processor; and
a computer readable medium coupled the processor, the computer readable medium comprising code, executable by the processor, for implementing a method comprising:
receiving, by an access device and from a token vault computer, an encryption key and a credential identifier;
generating, by the access device, a token using the encryption key and a current time; and
transmitting, by the access device, the token, the current time, and the credential identifier to the token vault computer.

10. The access device of claim 9, wherein after receiving the encryption key, the access device temporarily does not have communication with the token vault computer.

11. The access device of claim 10, wherein transmitting the token and the current time to the token vault computer is performed after communication between access device and the token vault computer is restored, wherein the token vault computer validates the token using the current time and the encryption key.

12. The access device of claim 11, wherein validating the token further comprises retrieving the encryption key based at least in part on the credential identifier received by the token vault computer.

13. The access device of claim 9, further comprising:
sending, by the access device, authentication credentials to the token vault computer, wherein the token vault computer validates the authentication credentials; and
storing, by the access device, the credential identifier and the encryption key on the access device.

14. The access device of claim 9, further comprising receiving account information from a communication device, wherein the account information comprises at least a primary account number (PAN).

15. The access device of claim 9, wherein the token vault computer stores information pertaining to an association between the token and the account information.

16. The access device of claim 9, wherein generating the token comprises generating a token having a token identifier from within a predefined Bank Identification Number (BIN) range.

17. A method for offline token generation, comprising:
receiving, by a token vault computer and from an access device, a token, a current time, and a credential identifier;
retrieving, by the token vault computer, an encryption key associated with the received credential identifier; and
validating, by the token vault computer, the token based at least in part on the received current time and the retrieved encryption key, wherein the token is generated by the access device.

18. The method of claim 17, further comprising storing, by the token vault computer, an association between the received token and information pertaining to a user account.

19. A token vault computer, comprising:
a processor; and
a computer readable medium coupled the processor, the computer readable medium comprising code, executable by the processor, for implementing a method comprising:
receiving, by a token vault computer and from an access device, a token, a current time, and a credential identifier;
retrieving, by the token vault computer, an encryption key associated with the received credential identifier; and
validating, by the token vault computer, the token based at least in part on the received current time and the retrieved encryption key, wherein the token is generated by the access device.

20. The token vault computer of claim 19, wherein the method further comprises storing, by the token vault computer, an association between the received token and information pertaining to a user account.
